(19) United States
(12) Patent Application Publication
(10) Pub. No.: US 2025/0208343 A1
(43) Pub. Date: Jun. 26, 2025

(54) PHOTONIC STRUCTURE HAVING EFFECTIVE REFRACTIVE INDEX PROFILE

(71) Applicant: Quantinuum LLC, Broomfield, CO (US)

(72) Inventors: Adam Jay OLLANIK, Boulder, CO (US); Molly KROGSTAD, Westminster, CO (US); Bryan DeBONO, Broomfield, CO (US); Mary ROWE, Boulder, CO (US); Rezlind BUSHATI, Rockville, MD (US); Johanna ZULTAK, Broomfield, CO (US)

(21) Appl. No.: 18/968,792

(22) Filed: Dec. 4, 2024

Related U.S. Application Data
(60) Provisional application No. 63/613,274, filed on Dec. 21, 2023.

(51) Int. Cl. G02B 6/122

(52) U.S. Cl. CPC G02B 6/1225

(57) ABSTRACT

Photonic structures and systems including photonic structures are provided. An example photonic structure includes a plurality of layers. Each layer includes a respective material of two or more materials. Each of the two or more materials has a respective refractive index. A first layer of the plurality of layers is at least partially disposed on a substrate. The respective refractive index of a first material of the two or more materials has a different refractive index than a second material of the two or more materials. Each layer of the plurality of layers has a thickness that is at most one tenth of an intended use wavelength.

### CROSS-REFERENCE TO RELATED APPLICATION(S)

This application claims priority to U.S. Application No. 63/613,274 filed Dec. 21, 2023, the content of which is incorporated herein by reference in its entirety.

### TECHNICAL FIELD

Various embodiments relate to photonic structures having an effective refractive index profile. For example, various embodiments relate to photonic structures having a non-zero effective refractive index gradient. For example, various embodiments relate to systems including photonic structures having an effective refractive index profile.

### BACKGROUND

Various systems include photonic structures such as waveguides, gratings, grating couplers, sub-wavelength waveguides, and waveplates. However, such photonic structures such as grating couplers may have relatively low coupling efficiency (e.g., 50% or less) due to, for example, the fact that conventional grating couplers outcouple light into multiple directions simultaneously. Photonic structures such as waveguides may not be configured to guide desired optical modes. For example, in a particular system it may be desired to guide a particular optical mode through a waveguide, but the waveguide may not be configured for propagating the particular optical mode. Through applied effort, ingenuity, and innovation many deficiencies of such photonic structures and systems including photonic structures have been solved by developing solutions that are structured in accordance with the embodiments of the present invention, many examples of which are described in detail herein.

### BRIEF SUMMARY OF EXAMPLE EMBODIMENTS

Example embodiments provide photonic structures having an effective refractive index profile and systems including photonic structures having effective refractive index profiles. Various embodiments provide photonic structures having non-zero effective refractive index gradients and systems including photonic structures having non-zero effective refractive index gradients.

In various embodiments, a photonic structure is formed of a plurality of layers. Each of the layers includes a respective material of two or more materials. Each of the two or more materials has a respective refractive index. Each layer of the plurality of layers has a thickness that is less than a wavelength that the photonic structure is configured for use with. The effective refractive index profile of the photonic structure has a non-zero gradient in a plane transverse to a propagation direction defined at least in part by the photonic structure, in an example embodiment.

According to one aspect, a photonic structure is provided. In an example embodiment, the photonic structure includes a plurality of layers. Each layer includes a respective material of two or more materials. Each of the two or more materials has a respective refractive index. The respective refractive index of a first material of the two or more materials has a different refractive index than a second material of the two or more materials. A first layer of the plurality of layers is at least partially disposed on a substrate.

In an example embodiment, each layer of the plurality of layers has a thickness that is less than an intended use wavelength.

In an example embodiment, each layer of the plurality of layers has a thickness that is at most one-tenth of an intended use wavelength.

In an example embodiment, the plurality of layers are substantially U-shaped layers.

In an example embodiment, the substantially U-shaped layers provides an asymmetry in a direction perpendicular to a surface of the substrate and the asymmetry is configured to cause coupling of one or more guided modes out of the photonic structure in preferred direction.

In an example embodiment, the layers of the plurality of layers are nested with one another.

In an example embodiment, the layers of the plurality of layers are nested with one another such that nesting of the layers provides an asymmetry configured to cause coupling of a guided mode out of the photonic structure in a preferred direction.

In an example embodiment, each layer of the plurality of layers has a thickness in a range of 0.1 nm to 200 nm.

In an example embodiment, the photonic structure is configured to perform at least one of supporting one or more guided modes; coupling optical beams between the one or more guided modes and one or more free space modes; manipulating optical characteristics of the one or more guided modes; manipulating optical characteristics of an optical signal as its coupled between the one or more free space modes and the one or more guided modes; manipulating optical characteristics of an optical signal as its coupled between the one or more guided modes and the one or more free space modes; inhibiting the propagation of the one or more guided modes; supporting one or more optical resonances; supporting the one or more guided mode with a delayed group velocity; or facilitating optical coupling between two or more additional photonic structures.

In an example embodiment, an effective refractive index profile of the photonic structure has a non-zero gradient across a cross-section of the photonic structure taken in a plane transverse to a propagation direction defined by the photonic structure.

In an example embodiment, the photonic structure defines a propagation direction and a width of the photonic structure in a direction perpendicular to the propagation direction changes along at least a portion of a length of the photonic structure in the propagation direction.

In an example embodiment, an effective refractive index profile and/or effective refractive index gradient of the photonic structure changes as the width of the photonic structure changes.

In an example embodiment, wherein the photonic structure is configured to change a polarization of a beam propagating therethrough.

According to another aspect, a system including one or more photonic structures is provided. In an example embodiment, the system includes one or more photonic structures; a confinement apparatus; and one or more manipulation sources. The one or more manipulation sources are configured to generate respective manipulation signals and the one or more photonic structures are configured to provide the respective manipulation signals to one or more target regions defined at least in part by the confinement apparatus for interaction with atomic objects confined by the confinement apparatus. Each of the one or more photonic structures includes a respective plurality of layers. Each layer includes a respective material of two or more materials. Each of the two or more materials has a respective refractive index. The respective refractive index of a first material of the two or more materials has a different refractive index than a second material of the two or more materials. A first layer of the plurality of layers is at least partially disposed on a substrate.

In an example embodiment, each layer of the plurality of layers has a thickness that is less than an intended use wavelength.

In an example embodiment, each layer of the plurality of layers has a thickness that is at most one-tenth of an intended use wavelength.

In an example embodiment, the plurality of layers are substantially U-shaped layers.

In an example embodiment, the substantially U-shaped layers provides an asymmetry in a direction perpendicular to a surface of the substrate and the asymmetry is configured to cause coupling of one or more guided modes out of the photonic structure in preferred direction.

In an example embodiment, the layers of the plurality of layers are nested with one another.

In an example embodiment, the layers of the plurality of layers are nested with one another such that nesting of the layers provides an asymmetry configured to cause coupling of a guided mode out of the photonic structure in a preferred direction.

In an example embodiment, each layer of the plurality of layers has a thickness in a range of 0.1 nm to 200 nm.

In an example embodiment, the photonic structure is configured to perform at least one of supporting one or more guided modes; coupling optical beams between the one or more guided modes and one or more free space modes; manipulating optical characteristics of the one or more guided modes; manipulating optical characteristics of an optical signal as its coupled between the one or more free space modes and the one or more guided modes; manipulating optical characteristics of an optical signal as its coupled between the one or more guided modes and the one or more free space modes; inhibiting the propagation of the one or more guided modes; supporting one or more optical resonances; supporting the one or more guided mode with a delayed group velocity; or facilitating optical coupling between two or more additional photonic structures.

In an example embodiment, an effective refractive index profile of the photonic structure has a non-zero gradient across a cross-section of the photonic structure taken in a plane transverse to a propagation direction defined by the photonic structure.

In an example embodiment, the photonic structure defines a propagation direction and a width of the photonic structure in a direction perpendicular to the propagation direction changes along at least a portion of a length of the photonic structure in the propagation direction.

In an example embodiment, an effective refractive index profile and/or effective refractive index gradient of the photonic structure changes as the width of the photonic structure changes.

In an example embodiment, wherein the photonic structure is configured to change a polarization of a beam propagating therethrough.

In an example embodiment, the system is a quantum computer.

In an example embodiment, the system is a quantum charge-coupled device (QCCD)-based quantum computer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a first cross-sectional view of an example photonic structure, in accordance with an example embodiment.

FIG. 2 provides a cross-sectional view of an example layer of an example photonic structure, in accordance with an example embodiment.

FIG. 3 provides a top view of a portion of an example system including example photonic structures, including the example photonic structure shown in FIG. 1, in accordance with an example embodiment.

FIG. 4 provides another cross-sectional view of the example photonic structure shown in FIGS. 1 and 3, in accordance with an example embodiment.

FIGS. 5A-5F illustrate the effective refractive index of cross-sections of various photonic structures having various effective refractive index gradients, in accordance with various embodiments.

FIG. 5G illustrates an example high-Q ring resonator, in accordance with various embodiments.

FIG. 6 provides a flowchart illustrating various processes and/or procedures of one example method for fabricating a photonic structure having an effective refractive index profile, in accordance with an example embodiment.

FIGS. 7A-7F provide cross-sectional views of various steps of fabricating a photonic structure having an effective refractive index profile, in accordance with an example embodiment.

FIG. 8 provides a schematic diagram of an example system including a photonic structure having a non-zero effective refractive index gradient, in accordance with an example embodiment.

FIG. 9 provides a schematic diagram of an example controller of a quantum computer comprising an atomic object confinement apparatus configured for confining atomic objects therein, in accordance with an example embodiment.

FIG. 10 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

Example embodiments provide photonic structures having a non-zero effective refractive index gradient and systems including photonic structures having a non-zero effective refractive index gradient. In various embodiments, a photonic structure is formed of a plurality of layers. Each of the layers includes a respective material and the plurality of layers include two or more materials. For example, the plurality of layers include layer A formed of material A and layer B formed of material B, where material A and material B are different materials.

Each of the two or more materials has a respective refractive index. For example, the refractive index of material A may be different from the refractive index of material B. Each layer has a thickness that is less than a wavelength of light that the photonic structure is configured and/or intended for use with. For example, in an example embodiment, each layer of the plurality of layers has a thickness that is at most one tenth of a wavelength of light that the photonic structure is configured and/or intended for use with. In various embodiments, the effective refractive index profile of the photonic structure has a non-zero gradient in a plane transverse to a propagation direction defined at least in part by the photonic structure. Thus, the photonic structure is a composite photonic structure comprising two or more materials that have been layered so as to provide a desired effective refractive index profile and/or effective refractive index gradient.

In various embodiments, the photonic structure is a grating coupler. Conventional grating couplers suffer from low coupling efficiency (e.g., 50% or less) due at least in part to the fact that conventional grating couplers outcouple light into multiple directions simultaneously. For example, the symmetry of a conventional grating coupler causes light to be coupled out of a grating coupler in the desired direction and also in the opposite direction in approximately equal amounts. As such, the highest coupling efficiency attainable with a conventional grating coupler, without support from other additional photonic structures designed to help the grating coupler achieve increased coupling efficiency (e.g., bottom reflectors), is 50%. Therefore, technical problems exist regarding efficient grating couplers.

Various embodiments provide technical solutions to these technical problems by providing photonic structures, such as grating couplers, for example, which have a non-zero effective refractive index gradient in a plane transverse to a propagation direction defined at least in part by the photonic structure. The non-zero gradient of the effective refractive index may be configured to break the symmetry between the desired coupling direction and the opposite direction such that light is preferentially coupled out of the grating coupler in the desired coupling direction. Therefore, various embodiments provide a technical solution to technical problems regarding efficient grating couplers.

Moreover, various other technical challenges exist regarding various photonic structures, such as waveguides. For example, in a particular system it may be desired to guide a particular optical mode through a waveguide. However, conventional waveguides may not be configured for propagating the desired optical mode. Therefore, technical problems exist regarding waveguides that may be configured for use with propagating particular optical modes.

Various embodiments provide technical solutions to these technical problems by providing photonic structures, such as waveguides, which have a non-zero effective refractive index gradient in a plane transverse to a propagation direction defined at least in part by the photonic structure. The non-zero effective refractive index gradient may be configured to promote the propagation of a particular optical mode and/or to suppress propagation of an undesired optical mode through the waveguide.

Thus, various embodiments provide various technical solutions and advantages to various technical problems and challenges that exist with regard to conventional photonic structures.

### Example Photonic Structure

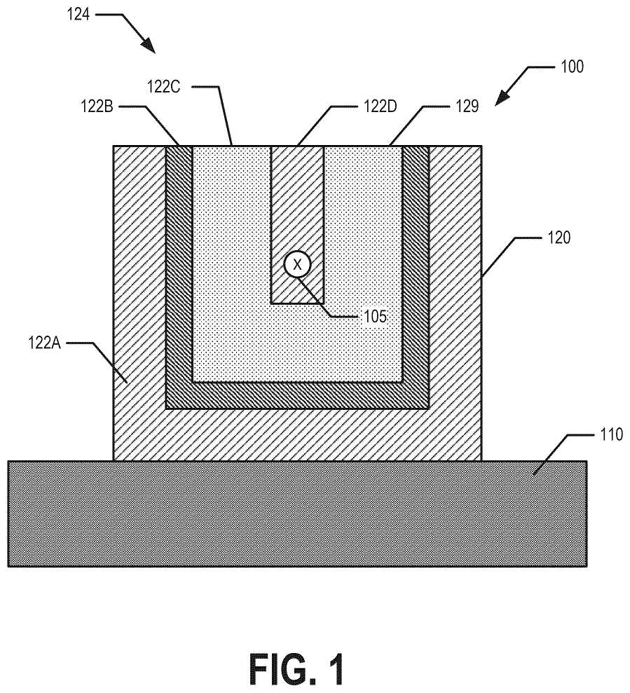

FIG. 1 provides a cross-sectional view of an example photonic assembly 100 taken at the A-A line of FIG. 3. The photonic assembly 100 includes one or more photonic structures. For example, as shown in FIG. 3, the photonic assembly 100 includes a first coupler 130A, waveguide 120, and a second coupler 130B. In various embodiments, the photonic assembly 100 may be at least a portion of a photonic integrated circuit (PIC), part of an electro-optical system, and/or the like.

As shown in FIG. 1, the waveguide 120 is formed on a substrate 110. The waveguide 120 comprises a plurality of layers 122 (e.g., 122A, 122B, 122C, 122D). The cross-sectional view of the waveguide 120 is taken in a plane perpendicular to the propagation direction 105 defined at least in part by the waveguide 120. While the waveguide 120 is shown as including four layers 122, in an example embodiment, the waveguide 120 may include a number of layers in the range of two layers to ten thousand layers.

In various embodiments, cross-sectional views of the first coupler 130A and/or second coupler 130B may be similar to that of the waveguide 120 in that the first coupler 130A and/or the second coupler 130B may comprise a plurality of generally U-shaped, nested layers configured to provide a desired effective refractive index profile and/or gradient.

In various embodiments, each layer 122 is formed of and/or comprises a respective material and the plurality of materials include two or more materials. For example, the plurality of layers include layer A formed of material A and layer B formed of material B, where material A and material B are different materials. For example, each layer 122 is formed of and/or comprises a respective material of two or more materials so as to provide a composite photonic structure comprising two or more materials that have been layered so as to provide a desired effective refractive index profile and/or effective refractive index gradient.

Each material of the two or more materials has and/or is characterized by a respective refractive index. In an example embodiment, each of the two or more materials has a different refractive index. For example, layer 122A is formed of a first material and has a first refractive index, layer 122B is formed of a second material and has a second refractive index, layer 122C is formed of a third material and has a third refractive index, and layer 122D is formed of the first material and has the first refractive index. The first, second, and third refractive indices are different from one another in an example embodiment. In another example embodiment, the first and second refractive indices are different from one another, and the third refractive index is substantially similar to the first refractive index or the second refractive index.

Some non-limiting examples of materials that may be used for various layers includes silicon dioxide (SiO₂), titanium dioxide (TiO₂), hafnium oxide (HfO₂), silicon (Si), and/or other materials appropriate for the application. For example, in an example embodiment, the effective refractive index profile and/or gradient of the photonic structure may be tailored to various applications by engineering and/or designing the layers of the photonic structures with a combination of lower refractive index materials (e.g., SiO₂, and/or the like) and higher refractive index materials (e.g., TiO₂, Si, HfO₂, and/or the like).

In an example embodiment, at least one of the two or more materials has non-linear properties. For example, in an example embodiment, the photonic structure is configured to facilitate and/or perform parametric frequency conversion through dispersion engineering of the waveguide effective refractive index.

In an example embodiment, each layer 122 is formed of and/or comprises a different material. In an example embodiment, the waveguide 120 includes layers 122 formed and/or comprising materials that alternate. For example, a first layer may be formed of a first material, a second layer may be formed of a second material, a third layer may be formed of a third material, a fourth layer may be formed of the first material, a fifth layer may be formed of the second material, and a sixth layer may be formed of the third material. In various embodiments, the layers are formed of materials that provide the desired effective refractive index gradient and effective refractive index profile.

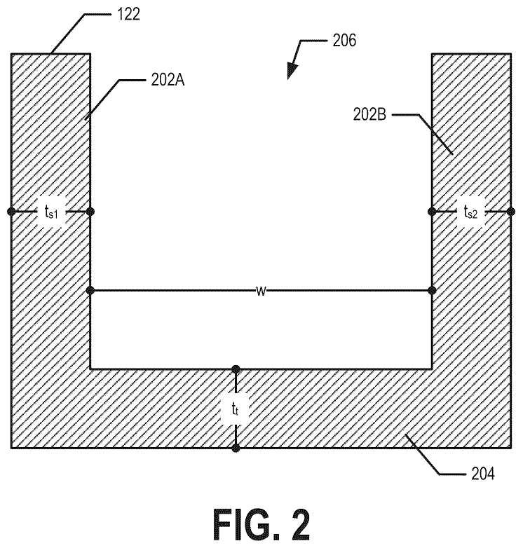

FIG. 2 illustrates an example layer 122. In various embodiments, each layer is substantially U-shaped. In an example embodiment, the central layer is substantially rectangular (e.g., a U-shape with a gap width of zero). For example, a layer 122 includes a first side 202A, a second side 202B, and a trough 204. The trough 204 connects a first end of the first side 202A and a first end of the second side 202B. A gap 206 is at least partially defined between the first side 202A and the second side 202B. In an example embodiment, the gap 206 is partially defined by the trough 204. The gap 206 has a width w. Each layer 122 defines a gap of a different width w. The final layer 122 (e.g., layer 122D in portion of the waveguide 120 shown in FIG. 1) has a gap width w that is equal to zero. For example, as shown in FIG. 1, the layers 122 are nested layers. For example, the fourth layer 122D is nested within the gap 206 defined by the third layer 122C, the third layer 122C is nested within the gap 206 defined by the second layer 122B, and the second layer 122B is nested within the gap 206 defined by the first layer 122A.

In various embodiments, the nested U-shaped layers 122 are configured to provide an asymmetry to the photonic structure in a cross-section taken perpendicular to the propagation direction 105 of the photonic structure. For example, the asymmetry provided by the nested U-shaped layers 122 is, in various embodiments, configured to provide out-of-plane coupling to a single free space direction. For example, the asymmetry provided by the nested U-shape layers 122 is, in various embodiments, configured to cause the photonic structure to preferentially couple light out of the photonic structure via open surface 129 (e.g., the surface facing the gaps 206 and/or openings of the U-shaped layers) and to preferentially not couple light out of the photonic structure via other surfaces of the photonic structure. In various embodiments, the asymmetry provided by the U-shaped layers 122 is accomplished within a single fabrication layer of the photonic assembly 100.

In an example embodiment, the first side 202A and the second side 202B extend out from the substrate 110 and/or trough 204. For example, the trough 204 is generally parallel to the surface of the substrate 110 on which the waveguide 120 is formed. The first side 202A and the second side 202B extend outward therefrom. For example, the first side 202A and the second side 202B form right angles with the trough 204, in an example embodiment.

The first side 202A has a first side thickness tₛ₁ that is substantially equal to a second side thickness tₛ₂. The thickness of the first side 202A and the second side 202B is measured in direction that is parallel to the surface of the substrate 110. The trough has a through thickness tₜ that is measured in a direction that is perpendicular to the surface of the substrate 110. In various embodiments, the first side thickness tₛ₁, the second side thickness tₛ₂, and the trough thickness tₜ are substantially equal to one another. For example, in various embodiments, the first side thickness tₛ₁ is substantially equal to the second side thickness tₛ₂, which is substantially equal to the trough thickness tₜ which is equal to a thickness t (e.g., tₛ₁=tₛ₂=tₜ=t).

In various embodiments, the thickness t is less than an intended use wavelength. In various embodiments, the thickness t is at most one tenth of an intended use wavelength. For example, a photonic structure (e.g., waveguide 120, couplers 130A, 130B, etc.) may be configured and/or intended for use with light of a particular wavelength or within a particular wavelength range. The thickness t is at most one tenth the particular wavelength or one tenth the shortest wavelength of the particular wavelength range, in various embodiments. For example, in a scenario where the waveguide 120 is configured for guiding light characterized by a wavelength of 532 nm, the intended use wavelength is 532 nm, and the thickness t of a layer 122 of the waveguide 120 is at most 53 nm. In various embodiments, each layer 122 of the plurality of layers has a thickness t in a range of 0.1 nm to 200 nm.

Because the layers 122 have respective thicknesses that are less than (e.g., at most one-tenth of) the intended use wavelength, light propagating through the photonic structure (e.g., waveguide 120) does not interact with each layer individually. For example, light propagating through the photonic structure does not experience a first layer having a first refractive index, a second layer having a second refractive index, etc. Rather the light propagating through the photonic structure experiences an effective refractive index that is influenced by the respective refractive indices of multiple layers 122.

In various embodiments, the thickness t of each layer may be uniform (e.g., the thickness t of a first layer 122A is equal to the thickness t of a second layer 122B is equal to the thickness t of a third layer 122C, etc.). In various embodiments, the thickness t of various layers is different. For example, the thickness t of a first layer 122A may be different from the thickness t of a second layer 122B. In various embodiments, the thickness of each layer 122 is configured to, in collaboration with the respective refractive index of the materials of the respective layers, provide the desired effective refractive index gradient in a plane perpendicular to the propagation direction 105 of the photonic structure.

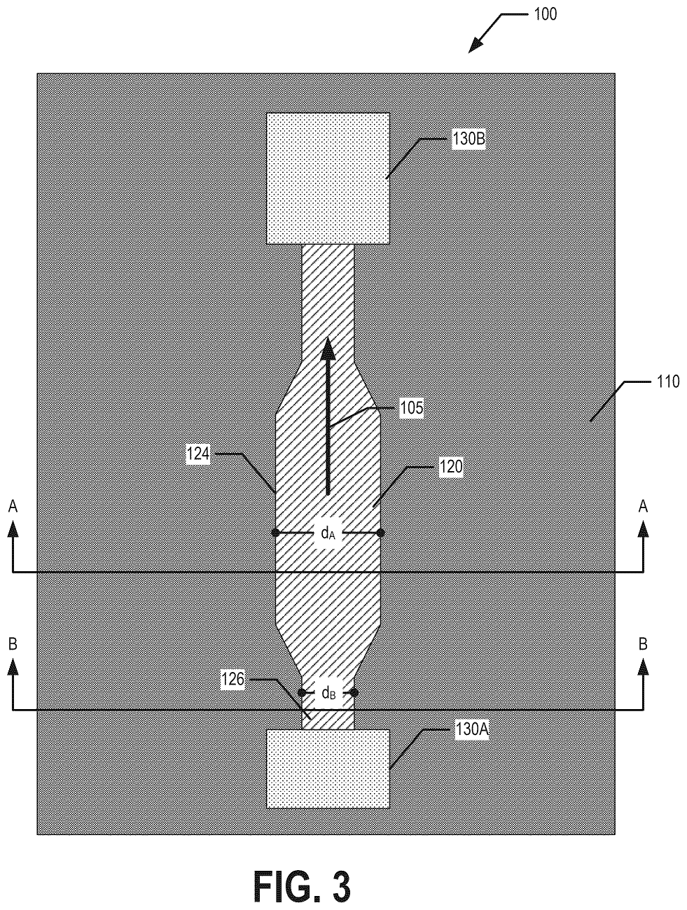

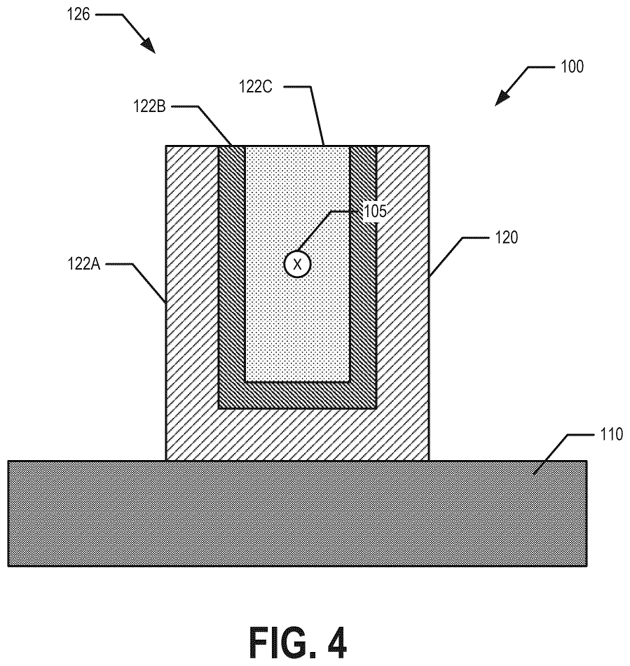

As shown in FIG. 3, the width of the photonic structure may change along a length of the photonic structure, where the length of the photonic structure is parallel to the propagation direction 105 of the photonic structure and the width is perpendicular to the propagation direction 105 of the photonic structure. For example, the waveguide 120 includes a wider portion 124 having a wider width d_{A} and a narrower portion 126 having a narrower width d_{B} (e.g., d_{A}>d_{B}). FIG. 1 provides a cross-sectional view of the wider portion 124 of the waveguide 120 and the FIG. 4 provides a cross-sectional view of the narrower portion 126 of the waveguide 120. In particular, FIG. 1 provides a cross-sectional view taken at line A-A of FIG. 3 and FIG. 4 provides a cross-sectional view taken at line B-B of FIG. 3.

The cross-section of the narrower portion 126 of the waveguide 120 includes three layers 122A, 122B, and 122C. For example, when the fourth layer 122D was formed, the gap 206 defined by the third layer 122C in the narrower portion 126 was equal to zero such that none of the material of the fourth layer 122D could be deposited therein. Thus, in various embodiments, the effective refractive index gradient may change and/or vary along a length of the photonic structure.

In various embodiments, one or more of the two or more materials used to form respective layers 122 of the waveguide 120 have wavelength dependent refractive indices and/or wavelength dependent responses. For example, a waveguide 120 may be used to guide modes of optical beams characterized by different wavelengths such that a first optical beam characterized by a first wavelength experiences a different effective refractive index profile of the waveguide 120 than a second optical beam characterized by a second wavelength. The first and the second wavelengths are different in this example.

As used herein, an effective refractive index profile is an indication of the effective refractive index of a photonic structure at various points on a cross-section of the photonic structure taken in a plane perpendicular to the direction of propagation of the photonic structure. For example, the effective refractive index profile indicates the effective refractive index of the photonic structure at a particular position along the length of the photonic structure (which is measured along the propagation direction 105 of the photonic structure) at a particular position or region of a plane take perpendicular to the propagation direction 105 at the particular position along the length of the photonic structure. In various embodiments, the effective refractive index indicates the effective refractive index of the photonic structure at a particular position along the length of the photonic structure (which is measured along the propagation direction 105 of the photonic structure) at each position or region of a plane take perpendicular to the propagation direction 105 at the particular position along the length of the photonic structure. In various embodiments, the effective refractive index indicates the effective refractive index of the photonic structure at each particular position along the length of the photonic structure (which is measured along the propagation direction 105 of the photonic structure) for each position or region of a plane take perpendicular to the propagation direction 105 at the particular position along the length of the photonic structure.

In various embodiments, the effective refractive index profile is constant and/or unchanging along a length of the photonic structure measured parallel to the direction of propagation of the photonic structure. In various embodiments, the effective refractive index profile changes along the length of the photonic structure. For example, the effective refractive index profile of the cross-section of the photonic structure (e.g., waveguide) 120 shown in FIG. 1 and taken along line A-A of FIG. 3 is different from the effective refractive index profile of the cross-section of the photonic structure (e.g., waveguide) 120 shown in FIG. 4 and taken along the line B-B of FIG. 3. In various embodiments, the effective refractive index profile varies along the length of the photonic structure in a periodic manner. In various embodiments, the effective refractive index profile varies along the length of the photonic structure in a non-periodic manner. In various embodiments, the effective refractive index profile varies along the length of the photonic structure as a result of and/or as a function of a change in width of the photonic structure (e.g., measured in a direction that is parallel to the surface of the substrate 110 and perpendicular to the propagation direction 105). For example, the effective refractive index profile of the cross-section of the photonic structure (e.g., waveguide) 120 shown in FIG. 1 and taken along line A-A of FIG. 3 is different from the effective refractive index profile of the cross-section of the photonic structure (e.g., waveguide) 120 shown in FIG. 4 and taken along the line B-B of FIG. 3 as a function of the wider width d_{A} being wider than the narrower width d_{B}.

In various embodiments, the effective refractive index profile is constant across a cross-section of the photonic structure. For example, in an example embodiment, the effective refractive index at various points on a cross-section of the photonic structure taken perpendicular to the direction of propagation are substantially and/or approximately equal to one another. For example, in an example embodiment, the effective refractive index gradient within a cross-section of the photonic structure take perpendicular to the direction of propagation of the photonic structure is approximately zero at all points on the cross-section. In various embodiments, the effective refractive index is not constant across a cross-section of the photonic structure take perpendicular to the direction of propagation of the photonic structure. For example, in various embodiments, the effective refractive index gradient at various points within a cross-section of the photonic structure take perpendicular to the direction of propagation of the photonic structure are not equal to zero (e.g., are non-zero).

In various embodiments, the effective refractive index profile and/or effective refractive index gradient within a cross-section of the photonic structure and/or along a length of the photonic structure are configured, designed, and/or engineered such that the photonic structure is configured for a respective application.

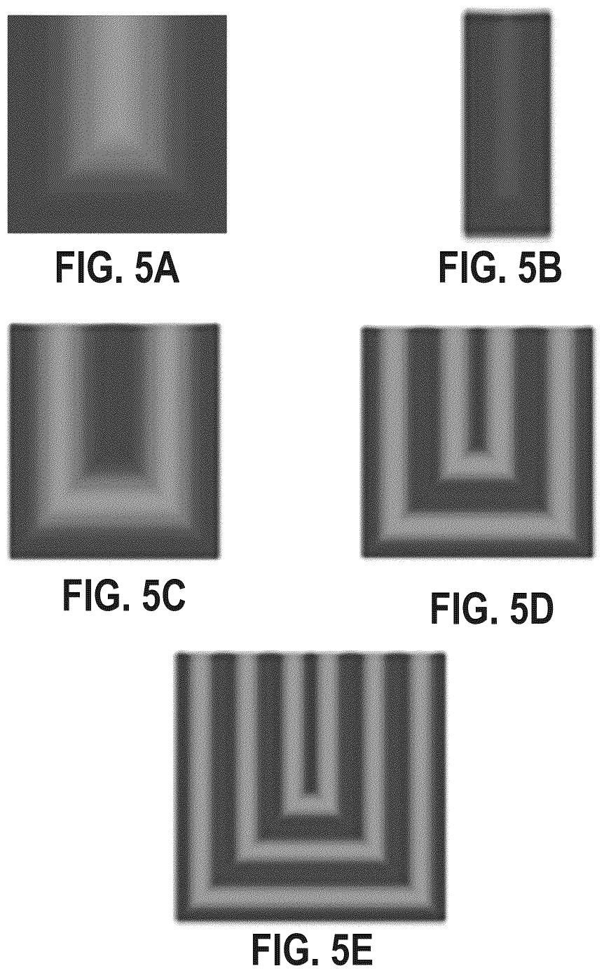

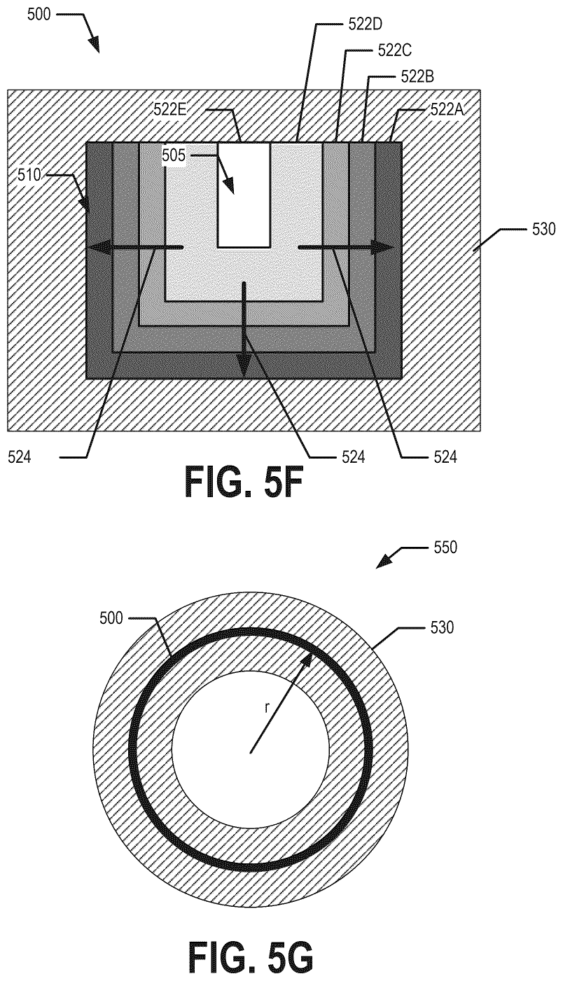

FIGS. 5A, 5B, 5C, 5D, and 5E each illustrate an example effective refractive index in a plane perpendicular to the direction of propagation of a respective photonic structure. For example, the blue/darker shade indicates a higher effective refractive index, and the green/lighter shade indicates a lower effective refractive index, or vice versa. As shown in FIGS. 5A and 5B, the refractive index may monotonically change (e.g., increase or decrease) from a substantially U-shaped edge of the photonic structure toward a central portion of the photonic structure. The example effective refractive indices shown in FIGS. 5A and 5B are formed via the same fabrication process, but because in the difference in the width of the respective photonic structures, the resulting effective refractive index gradients are also different. FIGS. 5C, 5D, and 5E illustrate some example effective refractive indices that are not monotonic.

Various embodiments provide photonic structures configured to support one or more guided modes; couple optical beams between guided and free space modes; manipulate optical characteristics of one or more guided modes such as wavelength, polarization, amplitude, phase, optical mode (e.g., Gaussian, Hermite-Gaussian, Laguerre-Gaussian, etc.), optical mode diameter (e.g., via a waveguide taper), effective index dispersion as a function of wavelength, and/or the like; manipulate optical characteristics of an optical signal as its coupled between one or more free space mode and one or more guided modes (or vice versa) such as wavelength, polarization, amplitude, phase, optical mode (e.g., Gaussian, Hermite-Gaussian, Laguerre-Gaussian, etc.), optical mode diameter (e.g., via a waveguide taper), effective index dispersion as a function of wavelength, propagation direction of the free space mode(s), and/or the like; inhibit the propagation of guided modes (e.g., a Bragg reflector); support one or more optical resonances; support a guided mode with a delayed group velocity; facilitate optical coupling between two or more photonic structures; and/or the like. For example, in various embodiments, the effective refractive index profile of the photonic structure is configured to enable and/or control one or more functional capabilities of the photonic structure.

For example, the effective refractive index profile and/or effective refractive index gradient at one or more points along the length of a photonic structure are configured, designed, and/or engineered such that the photonic structure is configured to support one or more guided modes; couple optical beams between guided and free space modes; manipulate optical characteristics of one or more guided modes; manipulate optical characteristics of an optical signal as its coupled between one or more free space mode and one or more guided modes (or vice versa); inhibit the propagation of guided modes; support one or more optical resonances; support a guided mode with a delayed group velocity; facilitate optical coupling between two or more photonic structures; and/or the like.

In various embodiments, a photonic structure is configured to support one or more guided modes with low scattering loss. For example, the effective refractive index gradient is configured to adiabatically approach the refractive index of the photonic structuring cladding. For example, FIG. 5F illustrates a cross-section of an example photonic structure 500 configured to support one or more guided modes with low scattering loss. The photonic structure 500 comprises a plurality of layers 522 (e.g., 522A-522E). While FIG. 5F only illustrates five layers 522, adiabatically transitioning from the refractive index at the core 505 of the photonic structure to the refractive index at the edge 510 likely includes more than five layers.

The plurality of layers 522 are enclosed on one or more sides and/or surfaces thereof by a cladding layer 530. The cladding layer 530 has a refractive index equal to a cladding refractive index n_{c}. The effective refractive index at the edge 510 of the photonic structure 500 is approximately equal to the cladding refractive index. The effective refractive index at the core 505 of the photonic structure is not equal to the cladding refractive index. For example, the effective refractive index at the core 505 of the photonic structure may be a high refractive index (e.g., greater than 1, greater than 1.5, and/or the like). The effective refractive index changes along directions 524 from the core 505 to the edge 510 of the photonic structure 500 adiabatically over at least a portion of the cross-section of the photonic structure 500. The change in the effective refractive index is adiabatic over at least a portion of the cross-section of the photonic structure 500 (e.g., the effective refractive index may change non-adiabatically in the core 505 of the photonic structure 500). In other words, in the at least a portion of the cross-section of the photonic structure 500, the effective refractive index changes slowly and smoothly. For example, the effective refractive index profile is effectively a continuous effective refractive index gradient (e.g., without abrupt discontinuities). For example, the change in the effective refractive index is adiabatic over at least a portion of the cross-section of the photonic structure 500 such that the change in the effective refractive index is slow enough and smooth enough to avoid (e.g., have a small probability) of scattering light out of the guided mode of the photonic structure.

FIGS. 5A-5E illustrate some other example effective refractive index profiles where the effective refractive index at the edge 510 of the photonic structure may be index-matched to the surrounding cladding layer 530.

The matching of the effective refractive index at the edge 510 of the photonic structure 500 to the refractive index of the cladding layer 530 results in less scattering occurring at the interface of the photonic structure 500 and the cladding layer 530. The reduction in scattering at the interface of the photonic structure 500 and the cladding layer 530 (compared to conventional waveguide-cladding interfaces) results in lower optical loss of optical beams guided along the photonic structure (compared to conventional waveguides). As the scattering losses across the waveguide-cladding interface scales with the square of the contrast between the waveguide refractive index at the interface and the cladding refractive index at the interface, various embodiments provide an improvement of ten to fifty or more times reduction in scattering losses over conventional waveguide-cladding interfaces.

In an example embodiment, the photonic structure 500 is a portion of a high quality (high-Q) photonic integrated circuit (PIC) ring resonator. For example, the photonic structure 500, in an example embodiment, is configured to support one or more guided modes in a ring configuration. For example, FIG. 5G illustrates a cross-sectional view of an example ring resonator 550 taken in plane defined by the ring resonator. For example, the ring resonator 550 includes the photonic structure 500 embedded in cladding layer 530. The photonic structure 500 is formed in a circular or elliptical configuration characterized by a bend radius r. In various embodiments, due to the reduced scattering at the interface of the photonic structure 500 and the cladding layer 530 (compared to conventional waveguide-cladding interfaces) the bend radius r is smaller than the bend radius of conventional low confinement waveguide ring resonators. For example, an example conventional low confinement waveguide ring resonator, the bend radius is generally around 750 μm. In various embodiments, the photonic structure is a low confinement waveguide that provides a high-Q ring resonator with a bend radius r of less than 500 μm, where the smaller bend radius r is enabled by the reduced scattering at the waveguide-cladding interface. For example, one example embodiment provides a high-Q ring resonator formed of a low confinement waveguide with a bend radius of 20 μm. Various embodiments provide a variety of high-Q ring resonators with lower than conventional scattering losses having a variety of bend radii, as appropriate for the respective applications.

In various embodiments, the ring resonator 550 is a high-Q ring resonator meaning that the ring resonator 550 has a high quality factor. In various embodiments, a high quality factor is a quality factor greater than one thousand, one hundred thousand, or one million, as appropriate for the application. In an example embodiment, the ring resonator 550 is a high-Q PIC ring resonator formed on and/or as part of a PIC.

In various embodiments, the effective refractive index profile and/or effective refractive index gradient of the photonic structure is configured for guiding a particular one or more optical modes and/or for controlling the optical mode propagating through the photonic structure. For example, the photonic structure could have a small core with a high refractive index and an outer or periphery portion with a lower refractive index such that the photonic structure is configured to guide optical modes having a large mode diameter (e.g., large compared to the size of the core) for coupling into or out of the photonic structure and/or for evanescent coupling. For example, such evanescent coupling may enable modulation and/or control of the light propagating through the photonic structure. For example, the effective refractive index profile and/or effective refractive index gradient of the photonic structure is configured for mode matching light being coupled into and/or out of the photonic structure, in an example embodiment.

FIGS. 5C-5E illustrate some example effective refractive index profiles that may be used for shaping and/or maneuvering one or more guided modes, producing birefringence, and/or manipulating the guided mode(s). For example, the effective refractive index profile may include one or more regions of low effective refractive index (e.g., along the edge 510 of the photonic structure and/or in one or more U-shaped regions of the photon structure with effective refractive index less than 1). The effective refractive index profile also includes one or more regions (e.g., rectangular, generally U-shaped, and/or the like) having a high effective refractive index (e.g., greater than 1, greater than 1.5, and/or the like). The pattern of low effective refractive index regions and high effective refractive index regions is configured shaping, maneuvering, manipulating, and/or the like one or more guided modes; producing birefringence; and/or performing another desired manipulation of light propagating through the photonic structure.

In an example embodiment, the effective refractive index of a photonic structure is configured to cause the polarization of a beam propagating therethrough to rotate. For example, the photonic structure may be a waveplate that causes the polarization of a beam propagating therethrough to change as a result of the beam of light interacting with the effective refractive index of the photonic structure.

In various embodiments, the photonic assembly 100 is a PIC and/or an electro-optical chip housing a PIC and evanescent coupling may be performed between one or more layers of the PIC and/or electro-optical chip. For example, various layers of the PIC and/or electro-optical chip may be made of different materials. Thus, direct coupling between various layers may be difficult. In various embodiments, a degree of evanescent coupling of one or more optical modes into and/or out of a photonic structure are controlled via the effective refractive index profile of the photonic structure. For example, the effective refractive index profile of the photonic structure may be configured to cause efficient evanescent coupling in one or more coupling portions of the photonic structure and configured to inhibit evanescent coupling in or more non-coupling portions of the photonic structure.

For example, in an example embodiment, the effective refractive index profile varies along the length of the photonic structure (measured in a direction parallel to the direction of propagation of the photonic structure) to encourage evanescent coupling of optical modes into and/or out of the photonic structures at one or more coupling portions along the length of the photonic structure and to inhibit evanescent coupling of optical modes into and/or out of the photonic structure at one or more non-coupling portions along the length of the photonic structure. In an example embodiment, the effective refractive index profile is caused to vary along the length of the photonic structure as a result of the width (measured in a plane parallel to the surface of the substrate housing the photonic structure and perpendicular to the direction of propagation of the photonic structure) varying along the length of the photonic structure.

For example, in an example embodiment, the width and the refractive index profile of the photonic structure in a coupling portion of the photonic structure is configured to cause a mode diameter of a guided mode to increase (e.g., as compared to in a non-coupling portion of the photonic structure) so as to facilitate evanescent coupling of the guided mode into and/or out of the photonic structure. For example, in an example embodiment, the width and the refractive index profile of the photonic structure in a non-coupling portion of the photonic structure is configured to cause a mode diameter of a guided mode to decrease (e.g., as compared to in a coupling portion of the photonic structure) so as to inhibit evanescent coupling of the guided mode into and/or out of the photonic structure.

For example, in an example embodiment, the width and the refractive index profile of the photonic structure in a coupling portion of the photonic structure is configured to cause a center of a guided mode to be located at a coupling position (e.g., closer to the open surface 129, as compared to in a non-coupling portion of the photonic structure) so as to facilitate evanescent coupling of the guided mode into and/or out of the photonic structure. For example, in an example embodiment, the width and the refractive index profile of the photonic structure in a non-coupling portion of the photonic structure is configured to cause the center of the guided mode to be located at a non-coupling position (e.g., further from the open surface 129, as compared to in a coupling portion of the photonic structure) so as to inhibit evanescent coupling of the guided mode into and/or out of the photonic structure.

In various embodiments, the two or more materials from which the layers of the photonic structure are formed include one or more non-linear materials. For example, in various embodiments, the photonic structure is configured for performing one or more non-linear optical functions, frequency conversion, and/or the like. For example, in various embodiments, the effective refractive index profile is configured for performance of non-linear and/or frequency conversion applications. For example, the photonic structure is configured for phase matching at various wavelengths.

For example, in an example embodiment, the photonic structure is configured for spontaneous parametric down-conversion, which is a non-linear process in which a single pump photon is split into two photons of shorter wavelength. During this process both energy conservation and momentum conservation must be satisfied. In order to satisfy energy conservation, the sum of the frequencies of the two photons of shorter wavelength is equal to the frequency of the pump photon. In order to satisfy momentum conservation, the wavevectors must be conserved. In general, performance of the spontaneous parametric down-conversion is optimized when the refractive index divided by the wavelength is phase matched for each of the pump photon and the two photons of shorter wavelength. In various embodiments, the photonic structure is dispersion engineered to be configured to provide the phase matching of each of the pump photon and the two photons of shorter wavelength. In various embodiments, the photonic structure is dispersion engineers through selection of dimensions of the photonic structure, the composite material of the photonic structure comprising the plurality of layers of two or more materials, and the effective refractive index profile of photonic structure.

### Example Method of Fabricating a Photonic Structure

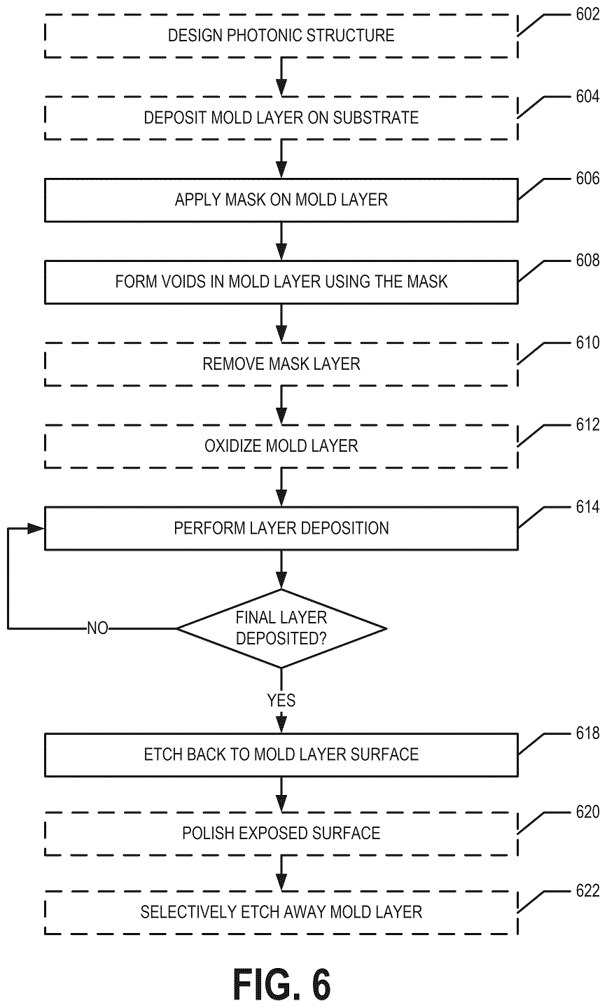

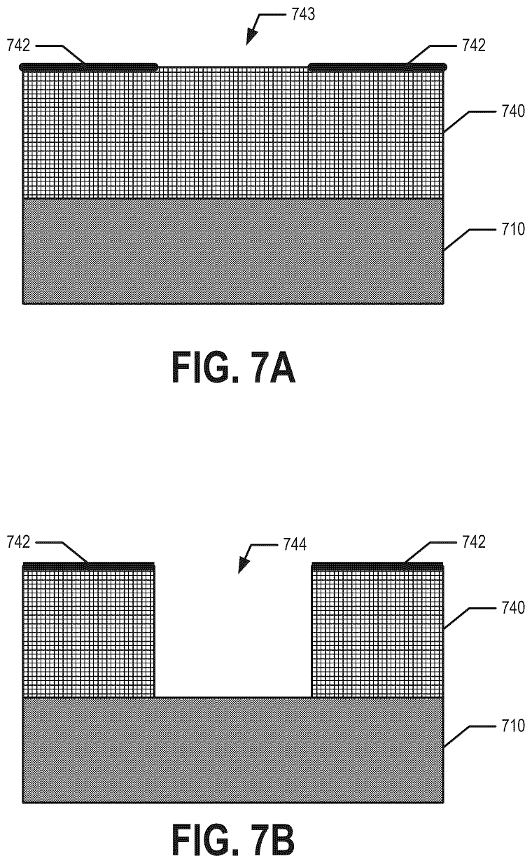

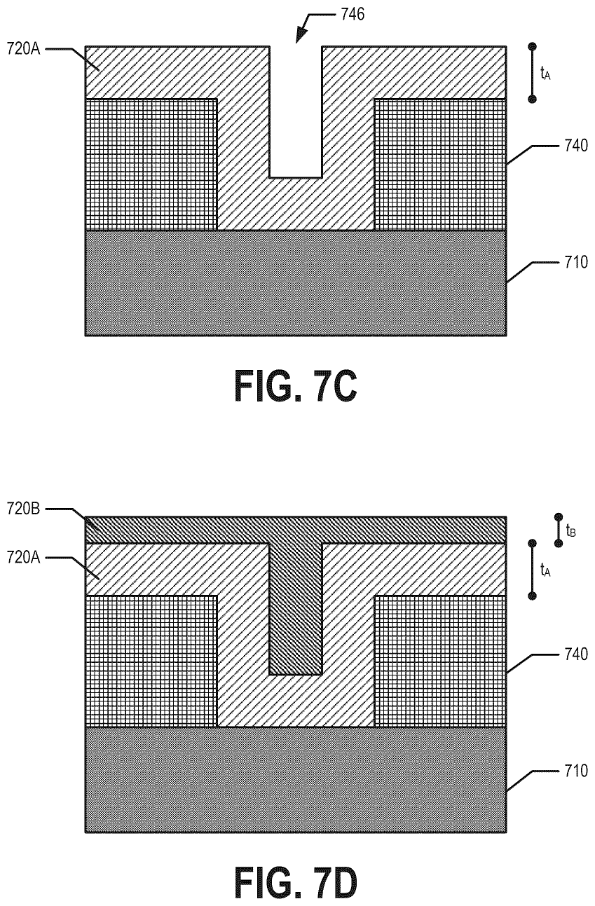

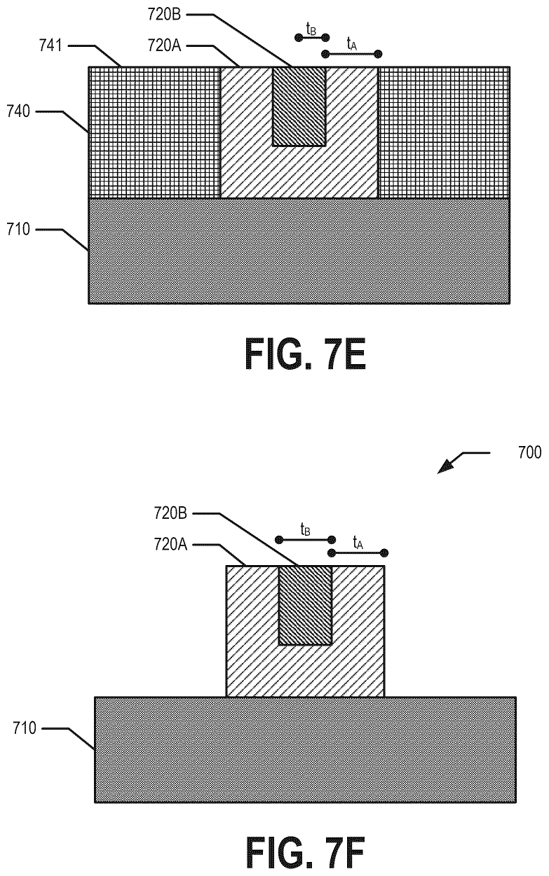

FIG. 6 provides a flowchart illustrating various processes and/or procedures of an example method for fabricating a photonic structure of an example embodiment. FIGS. 7A-7F provide cross-sectional views of several of the steps of fabricating an example photonic structure. As should be understood, various other methods may be used to fabricate example photonic structures of various embodiments.

Starting at step 602, the photonic structure is engineered and/or designed. For example, based on the desired function of the photonic structure and the intended use wavelength, a number of layers, thickness of each layer, material of each layer, and/or the like may be selected and/or defined. For example, simulation and/or various other photonics engineering processes may be used to engineer and/or design the photonic structure.

At step 604, a mold layer is deposited on a substrate. For example, a mold layer of a desired depth is deposited on a substrate. In various embodiments, the substrate is a wafer that includes silicon (Si), silicon dioxide (SiO₂), silicon nitride (Si₃N₄), germanium (Ge), or a combination thereof. In various embodiments, the mold layer can include any material that can be subsequently removed, such as removed by etching and/or oxidized to form a cladding of the photonic structure. For example, the mold layer may include aluminum (Al), Si₃N₄, SiO₂, or a combination thereof. The mold layer can be applied and/or deposited on the substrate using various deposition processes as appropriate for the material of the mold layer.

In an example embodiment, the mold layer is part of the substrate. For example, the mold layer may not need to be deposited on the substrate as part of the fabrication process.

At step 606, a mask is deposited on the mold layer. For example, a lithographic process is used to form a mask on the mold layer. For example, a mask may be lithographically defined on the mold layer.

FIG. 7A illustrates a cross-sectional view of a mold layer 740 formed on a substrate 710 and having a mask 742 defined thereon. The mask defines one or more openings 743 formed therein where the mold layer 740 is exposed.

At step 608, voids are formed in the mold layer 740 using the mask 742. For example, as shown in FIG. 7B, a void 744 may be formed in the mold layer 740 by etching the mold layer 740 through the one or more openings 743 of the mask 742. For example, the voids 744 may be formed through the mold layer 740 by etching the mold layer 740 via an etching process appropriate for the material of the mold layer 740. In an example embodiment, the mold layer 740 is etched down to the surface of the substrate 710 (or an etch stop layer formed in the substrate if the mold layer 740 is part of the substrate 710).

At step 610, the mask 742 may be optionally removed. For example, a selective etching process may be used to remove the mask 742 once the voids 744 are formed in the mold layer 740. In an example embodiment, the mask 742 is removed in a later step.

At step 612, the mold layer 740 is optionally oxidized. For example, in an example embodiment, the mold layer 740 is retained as a cladding of the photonic structure and the mold layer 740 is oxidized to form the cladding.

At step 614, a first layer of the plurality of layers is deposited. In various embodiments, the layer is deposited using a conformal deposition process. For example, the layer may be deposited using a deposition process that is appropriate for the material of the layer. In various embodiments, the layer is deposited using a chemical vapor deposition (CVD) process, such as an atomic layer deposition (ALD) process.

FIG. 7C illustrates a cross-section after the first layer 720A of a first material is deposited on the mold layer 740 and within the voids 744. The first layer 720A is deposited to a first thickness t_{A}. The first layer 720A defines a decreased gap 746. The first thickness t_{A} is within a range of one nm to fifty nm, in various embodiments.

Step 614 is repeated for each additional layer of the photonic structure. For example, FIG. 7D illustrates a cross-section after the second layer 720B of a second material is deposited on the first layer 720A and within the decreased gap 746. The second layer 720B is deposited to a second thickness t_{B}. The second thickness t_{B} is within a range of one nm to fifty nm, in various embodiments.

Additional layers of the photonic structure are deposited in accordance with the design of the photonic structure. Once all of the layers of the photonic structure have been deposited, the process continues to step 618.

At step 618, etching is performed to etch back to the surface of the mold layer. For example, the portion of the layers that were deposited on the mold layer and/or that over-flowed the voids 744 is removed with an etching process. FIG. 7E illustrates the result of etching away the portions of the layers that were deposited on the mold layer and/or that over-flowed the voids 744 to expose the surface 741 of the mold layer 740.

At step 620, the surface 741 of the mold layer 740 and the exposed surfaces of the layers 720 are smoothed and/or polished. For example, a chemical mechanical polishing (CMP) process may be used to smooth and/or polish the surface 741 of the mold layer 740 and/or the exposed surfaces of the layers 720.

At step 622, the mold layer 740 may be removed. For example, in an example embodiment, a selective etching process is used to selectively etch away the mold layer 740. For example, FIG. 7F illustrates an example photonic structure 700 including a plurality of nested, substantially U-shaped layers 720 formed on a substrate 710.

### Example System Including Photonic Structure

Various systems may include photonic structures to guide, condition, and/or control photonic/optical signals for various purposes. For example, the photonic/optical signals may be used to interact with trapped particles such as atoms, ions, molecules, quantum dots, and/or the like. One example system that may include photonic structures according to various embodiments is a quantum computer.

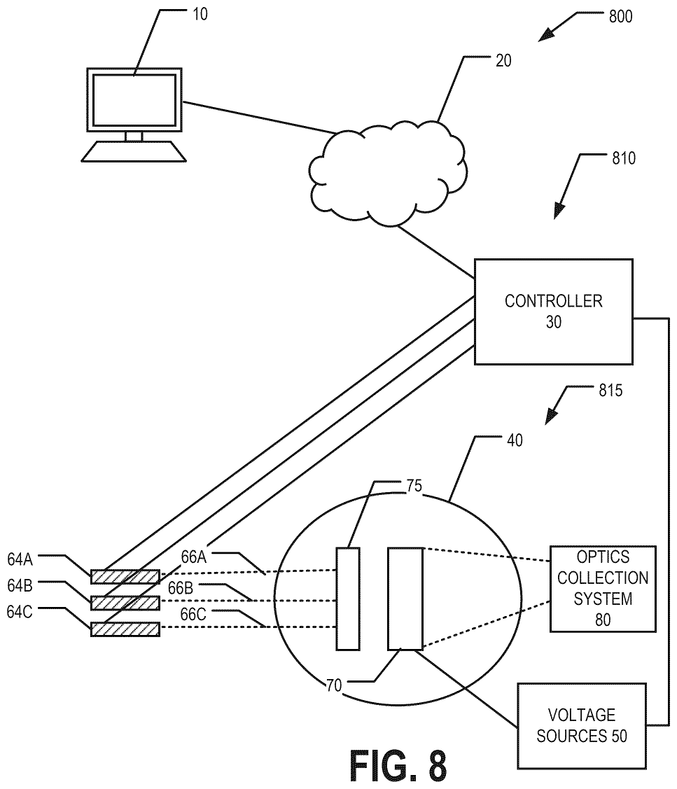

FIG. 8 provides a schematic diagram of an example quantum charge-coupled device (QCCD)-based quantum computer system 800 comprising a confinement apparatus 70 (e.g., an ion trap), in accordance with an example embodiment. In various embodiments, the quantum computer system 800 comprises a computing entity 10 and a quantum computer 810. In various embodiments, the quantum computer 810 comprises a controller 30 and a quantum processor 815 including a cryostat and/or vacuum chamber 40 enclosing a confinement apparatus 70, one or more manipulation sources 64 (e.g., 64A, 64B, 64C), one or more voltage sources 50, one or more magnetic field generators, an optics collection system 80, and/or the like. In various embodiments, the controller 30 is configured to control the operation of (e.g., control one or more drivers configured to cause operation of) the manipulation sources 64, voltage sources 50, magnetic field generators, a vacuum system and/or cryogenic cooling system (not shown), and/or the like. In various embodiments, the controller 30 is configured to receive signals (e.g., electrical signals) generated and provided by one or more photodetectors of the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic objects confined by the confinement apparatus 70. For example, a manipulation source 64 may generate and provide a manipulation signal that is caused to be incident on one or more atomic objects confined by the confinement apparatus 70 via one or more beam paths 66 (e.g., 66A, 66B, 66C), photonic integrated circuits 75, and/or the like. In various embodiments, the one or more beam paths 66 and/or photonic integrated circuit 75 includes one or more photonic structures in accordance with an example embodiment. For example, the one or more optical beam paths 66 and/or photonic integrated circuit 75 includes one or more photonic structures having an engineered and/or designed effective refractive index profile and/or gradient.

In various embodiments, the atomic object confinement apparatus 70 is an ion trap, such as a surface ion trap, Paul ion trap, and/or the like. In various embodiments, the atomic objects are ions, atoms, molecules, and/or the like. In an example embodiment, an object crystal comprises two or more atomic objects having different masses, atomic numbers, and/or molecular compositions. In an example embodiment, an object crystal includes one or more a first atomic objects (e.g., atomic objects having a first atomic number) that are used as cooling atomic objects in a sympathetic cooling scheme for the object crystal. In an example embodiment, the object crystal includes one or more second atomic objects (e.g., atomic objects having a second atomic number) that are used as qubits of the quantum computer 810. For example, in an example embodiment, the object crystal is an ion crystal comprising a singly ionized Ba atom used as a cooling ion and a singly ionized Yb ion used as a qubit ion. In another example embodiment, the object crystal is an ion crystal comprising a singly ionized Yb atom used as a cooling ion and a singly ionized Ba ion used as a qubit ion. In an example embodiment, an object crystal includes one first atomic object and one second atomic object. In an example embodiment, an object crystal includes two first atomic objects and two second atomic objects. In various embodiments an object crystal may include various numbers and combinations of atomic objects.

In an example embodiment, the one or more manipulation sources 64 each provide a manipulation signal (e.g., laser beam and/or the like) to one or more regions and/or target locations of the atomic object confinement apparatus 70 via corresponding beam paths 66 (e.g., 66A, 66B, 66C). In various embodiments, at least one beam path 66 comprises a modulator configured to modulate the manipulation signal being provided to the confinement apparatus 70 via the beam path 66. In various embodiments, the manipulation sources 64, active components of the beam paths (e.g., modulators, etc.), and/or other components of the quantum computer 810 are controlled by the controller 30.

In various embodiments, the quantum computer 810 comprises one or more voltage sources 50. For example, the voltage sources may be arbitrary wave generators (AWG), digital analog converters (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes and/or RF electrodes, and/or the like) of the confinement apparatus 70, in an example embodiment.

In various embodiments, the quantum computer 810 comprises one or more magnetic field generators. For example, the magnetic field generator may be an internal magnetic field generator disposed within the cryogenic and/or vacuum chamber 40 and/or an external magnetic field generator disposed outside of the cryogenic and/or vacuum chamber 40. In various embodiments, the magnetic field generators comprise permanent magnets, Helmholtz coils, electrical magnets, and/or the like. In various embodiments, the magnetic field generators are configured to generate a magnetic field at one or more regions and/or target locations of the atomic object confinement apparatus 70 that has a particular magnitude and a particular magnetic field direction in the one or more regions and/or target locations of the atomic object confinement apparatus 70.

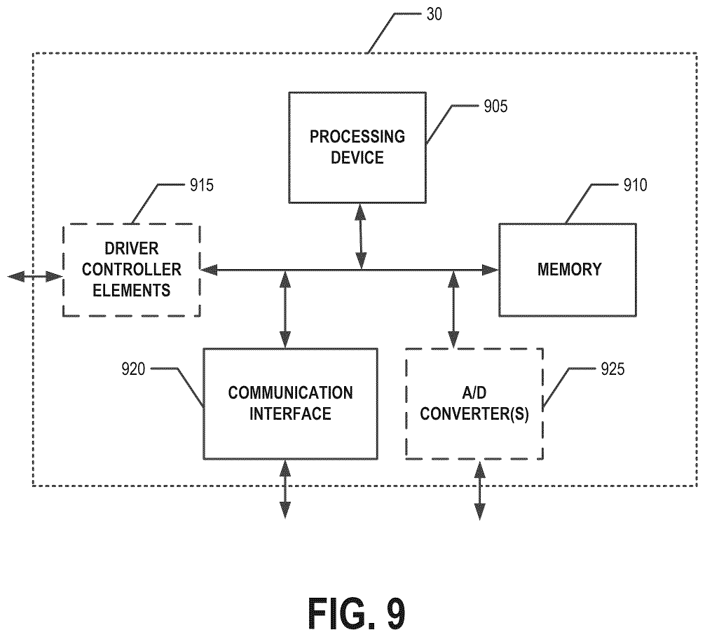

In various embodiments, the quantum computer 810 comprises an optics collection system 80 configured to collect and/or detect photons (e.g., stimulated emission) generated by qubits (e.g., during reading procedures). The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits (e.g., atomic objects) of the quantum computer 810. In various embodiments, the detectors may be in electronic communication with the controller 30 via one or more A/D converters 925 (see FIG. 9) and/or the like.

In various embodiments, a computing entity 10 is configured to allow a user to provide input to the quantum computer 810 (e.g., via a user interface of the computing entity 10) and receive, view, and/or the like output from the quantum computer 810. The computing entity 10 may be in communication with the controller 30 of the quantum computer 810 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 50, magnetic field generators, cryogenic system and/or vacuum system controlling the temperature and pressure within the cryogenic and/or vacuum chamber 40, manipulation sources 64, active components of beam paths 66, and/or other systems controlling various environmental conditions (e.g., temperature, pressure, and/or the like) within the cryogenic and/or vacuum chamber 40, configured to manipulate and/or cause a controlled evolution of quantum states of one or more atomic objects within the confinement apparatus, and/or read and/or detect a quantum (e.g., qubit) state of one or more atomic objects within the confinement apparatus. For example, the controller 30 may cause a controlled evolution of quantum states of one or more atomic objects within the confinement apparatus to execute a quantum circuit and/or algorithm. For example, the controller 30 may read and/or detect quantum states of one or more atomic objects within the confinement apparatus at one or more points during the execution of a quantum circuit. In various embodiments, the atomic objects confined by the confinement apparatus are used as qubits of the quantum computer 810.

### Technical Advantages

Various embodiments provide improved photonic structures and/or systems that include improved photonic structures. For example, various photonic structures disclosed herein have effective refractive index profiles and/or gradients configured for improved performance of the photonic structure compared to conventional photonic structures for various applications.

In various embodiments, the photonic structure is a grating coupler. Conventional grating couplers suffer from low coupling efficiency (e.g., 50% or less) due at least in part to the fact that conventional grating couplers outcouple light into multiple directions simultaneously. For example, the symmetry of a conventional grating coupler causes light to be coupled out of a grating coupler in the desired direction and also in the opposite direction in approximately equal amounts. As such, the highest coupling efficiency attainable with a conventional grating coupler, without support from other additional photonic structures designed to help the grating coupler achieve increased coupling efficiency (e.g., bottom reflectors), is 50%. Therefore, technical problems exist regarding efficient grating couplers.

Various embodiments provide technical solutions to these technical problems by providing photonic structures, such as grating couplers, for example, which have a non-zero effective refractive index gradient and/or an asymmetric effective refractive index profile in a cross-section taken in a plane transverse to a propagation direction defined at least in part by the photonic structure. The non-zero gradient of the effective refractive index and/or asymmetry of the effective refractive index profile may be configured to break the symmetry between the desired coupling direction and the opposite direction such that light is preferentially coupled out of the grating coupler in the desired coupling direction. Therefore, various embodiments provide a technical solution to technical problems regarding efficient grating couplers.

Moreover, various other technical challenges exist regarding various photonic structures, such as waveguides. For example, in a particular system it may be desired to guide a particular optical mode through a waveguide. However, conventional waveguides may not be configured for propagating the particular optical mode. Therefore, technical problems exist regarding waveguides that may be configured for use with propagating particular optical modes.

Various embodiments provide technical solutions to these technical problems by providing photonic structures, such as waveguides, which have a non-zero effective refractive index gradient in a plane transverse to a propagation direction defined at least in part by the photonic structure. The non-zero effective refractive index gradient may be configured to promote the propagation of a particular optical mode and/or to suppress propagation of an undesired optical mode through the waveguide. Various embodiments provide photonic structures having an application-tailored effective refractive index profile such that the photonic structures are configured for particular applications.

Thus, various embodiments provide various technical solutions and advantages to various technical problems and challenges that exist with regard to conventional photonic structures. Systems including these advantageous photonic structures are improved by the improved efficiency and/or effectiveness of the photonic structures.

### Example Controller

In various embodiments, a quantum computer 810 or other system including photonic structures of various embodiments includes a controller 30 configured to control various elements of the quantum computer 810 or other system. For example, the controller 30 may be configured to control the voltage sources 50, a cryogenic system and/or vacuum system controlling the temperature and pressure within the cryogenic and/or vacuum chamber 40, manipulation sources 64 (e.g., 64A, 64B, 64C), magnetic field generators, active components of beam paths 66, and/or other systems controlling the environmental conditions (e.g., temperature, humidity, pressure, and/or the like) within the cryogenic and/or vacuum chamber 40, configured to manipulate and/or cause a controlled evolution of quantum states of one or more atomic objects confined by the confinement apparatus, and/or read and/or detect a quantum state of one or more atomic objects within the confinement apparatus.

As shown in FIG. 9, in various embodiments, the controller 30 may comprise various controller elements including processing device 905, memory 910, driver controller elements 915, a communication interface 920, analog-digital converter elements 925, and/or the like. For example, the processing device 905 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 1005 of the controller 30 comprises a clock and/or is in communication with a clock.

For example, the memory 910 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 910 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 1010 (e.g., by a processing device 1005) causes the controller 30 to perform one or more steps, operations, processes, procedures and/or the like described herein for controlling one or more components of the quantum computer 810 or other atomic system (e.g., voltage sources 50, manipulation sources 64, magnetic field generators, active components of beam paths 66, and/or the like) to cause a controlled evolution of quantum states of one or more atomic objects, detect and/or read the quantum state of one or more atomic objects, and/or the like.

In various embodiments, the driver controller elements 1015 may include one or more drivers and/or controller elements each configured to control one or more drivers. In various embodiments, the driver controller elements 1015 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1005). In various embodiments, the driver controller elements 1015 may enable the controller 30 to operate a manipulation source 64. In various embodiments, the drivers may be laser drivers; vacuum component drivers; drivers for controlling the flow of current and/or voltage applied to longitudinal, RF, and/or other electrodes used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes and/or RF electrodes of the confinement apparatus 70. In various embodiments, the controller 30 comprises means for communicating and/or receiving signals from one or more detectors such as optical receiver components (e.g., cameras, MEMs cameras, CCD cameras, photodiodes, photomultiplier tubes, and/or the like). For example, the controller 30 may comprise one or more analog-digital converter elements 925 configured to receive signals from one or more detectors, optical receiver components, calibration sensors, photodetectors of an optics collection system 80, and/or the like.

In various embodiments, the controller 30 may comprise a network interface 1020 for interfacing and/or communicating with a computing entity 10. For example, the controller 30 may comprise a network interface 1020 for receiving executable instructions, command sets, and/or the like from the computing entity 10 and providing output received from the quantum computer 810 (e.g., from an optics collection system 80 comprising one or more photodetectors) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

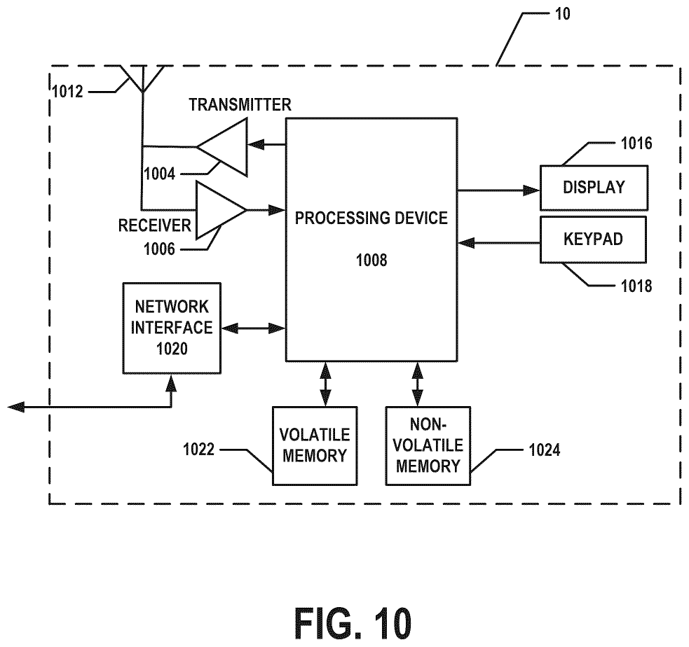

FIG. 10 provides an illustrative schematic representative of an example computing entity 10 that can be used in conjunction with embodiments of the present invention. In various embodiments, a computing entity 10 is configured to allow a user to provide input to the quantum computer 810 (e.g., via a user interface of the computing entity 10) and receive, display, analyze, and/or the like output from the quantum computer 810.

As shown in FIG. 10, a computing entity 10 can include an antenna 1012, a transmitter 1004 (e.g., radio), a receiver 1006 (e.g., radio), and a processing device 1008 that provides signals to and receives signals from the transmitter 1004 and receiver 1006, respectively. The signals provided to and received from the transmitter 1004 and the receiver 1006, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 1020 configured to communicate via one or more wired and/or wireless networks 20.

In various embodiments, the processing device 1008 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products.

The computing entity 10 may also comprise a user interface device comprising one or more user input/output interfaces (e.g., a display 1016 and/or speaker/speaker driver coupled to a processing device 1008 and a touch screen, keyboard, mouse, and/or microphone coupled to a processing device 1008). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1018 (hard or soft), a touch display, voice/speech or motion interfaces, scanners, readers, or other input device. In embodiments including a keypad 1018, the keypad 1018 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1022 and/or non-volatile storage or memory 1024, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A photonic structure comprising:
a plurality of layers, wherein each layer comprises a respective material of two or more materials, each of the two or more materials having a respective refractive index,
wherein:
a first layer of the plurality of layers is at least partially disposed on a substrate, and
the respective refractive index of a first material of the two or more materials having a different refractive index than a second material of the two or more materials.

2. The photonic structure of claim 1, wherein each layer of the plurality of layers has a thickness that is less than an intended use wavelength.

3. The photonic structure of claim 1, wherein the plurality of layers are substantially U-shaped layers.

4. The photonic structure of claim 3, wherein the substantially U-shaped layers provides an asymmetry in a direction perpendicular to a surface of the substrate and the asymmetry is configured to cause coupling of one or more guided modes out of the photonic structure in preferred direction.

5. The photonic structure of claim 1, wherein layers of the plurality of layers are nested with one another.

6. The photonic structure of claim 5, wherein the layers of the plurality of layers are nested with one another such that nesting of the layers provides an asymmetry configured to cause coupling of a guided mode out of the photonic structure in a preferred direction.

7. The photonic structure of claim 1, wherein each layer of the plurality of layers has a thickness in a range of 0.1 nm to 200 nm.

8. The photonic structure of claim 1, wherein the photonic structure is configured to perform at least one of supporting one or more guided modes; coupling optical beams between one or more guided modes and one or more free space modes; manipulating optical characteristics of the one or more guided modes; manipulating optical characteristics of an optical signal as its coupled between the one or more free space modes and the one or more guided modes; manipulating optical characteristics of the optical signal as its coupled between the one or more guided modes and the one or more free space modes; inhibiting propagation of the one or more guided modes; supporting one or more optical resonances; supporting one or more guided modes with a delayed group velocity; or facilitating optical coupling between two or more additional photonic structures.

9. The photonic structure of claim 1, wherein an effective refractive index of the photonic structure has a non-zero gradient across a cross-section of the photonic structure.

10. The photonic structure of claim 1, wherein the photonic structure defines a propagation direction and a width of the photonic structure in a direction perpendicular to the propagation direction changes along at least a portion of a length of the photonic structure in the propagation direction.

11. The photonic structure of claim 10, wherein an effective refractive index profile of the photonic structure changes as the width of the photonic structure changes.

12. The photonic structure of claim 1, wherein the photonic structure is configured to change a polarization of a beam propagating therethrough.

13. A system comprising:
one or more photonic structures, each of the one or more photonic structures comprising:
a plurality of layers, wherein each layer comprises a respective material of two or more materials, each of the two or more materials having a respective refractive index, wherein:
a first layer of the plurality of layers is at least partially disposed on a substrate, and
the respective refractive index of a first material of the two or more materials having a different refractive index than a second material of the two or more materials;
a confinement apparatus; and
one or more manipulation sources,
wherein the one or more manipulation sources are configured to generate respective manipulation signals and the one or more photonic structures are configured to provide the respective manipulation signals to one or more target regions defined at least in part by the confinement apparatus for interaction with atomic objects confined by the confinement apparatus.

14. The system of claim 13, wherein the system is a quantum computer.

15. The system of claim 13, wherein each layer of the plurality of layers has a thickness that is less than an intended use wavelength.

16. The system of claim 13, wherein the plurality of layers are substantially U-shaped layers.

17. The system of claim 16, wherein the substantially U-shaped layers provides an asymmetry in a direction perpendicular to a surface of the substrate and the asymmetry is configured to cause coupling of one or more guided modes out of a photonic structure of the one or more photonic structures in preferred direction.

18. The system of claim 13, wherein the layers of the plurality of layers are nested with one another.

19. The system of claim 18, wherein the layers of the plurality of layers are nested with one another such that nesting of the layers provides an asymmetry configured to cause coupling of a guided mode out of a photonic structure of the one or more photonic structures in a preferred direction.

20. The system of claim 13, wherein an effective refractive index of a photonic structure of the one or more photonic structures has a non-zero gradient across a cross-section of the photonic structure.
